(19) United States
(12) Patent Application Publication
(10) Pub. No.: US 2008/0188297 A1
(43) Pub. Date: Aug. 7, 2008

(54) PROGRESSIVE GAMING DEVICE AND METHOD OF USE

(75) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(73) Assignee: Atlantic City Coin & Slot Service Company, Inc., Pleasantville, NJ (US)

(21) Appl. No.: 12/026,397

(22) Filed: Feb. 5, 2008

Related U.S. Application Data
(60) Provisional application No. 60/888,273, filed on Feb. 5, 2007.

(51) Int. Cl. A63F 13/00

(52) U.S. Cl. 463/27

(57) ABSTRACT

A gaming apparatus includes a primary gaming device that is adapted to accept a wager and allow a player to play a game. A bonus gaming device is mourned in association with the primary gaming device. The bonus gaming device can award a bonus prize. A controller is in communication with the primary gaming device and the bonus gaming device. The controller is adapted to determine the bonus prize and to provide a progressive jackpot. When a bonus prize is awarded, the progressive jackpot is funded.

### CROSS REFERENCE TO RELATED AND CO-PENDING APPLICATIONS

This patent application claims priority to U.S. Provisional Patent Application Ser. No. 60/888,273, filed on Feb. 5, 2007. The entire contents of which are herein incorporated by reference.

### FIELD OF THE INVENTION

The present invention relates to gaming devices and, more particularly, to a gaming device that provides progressive jackpots that can change and be funded in several ways.

### BACKGROUND

Gaming devices are well known in the art and a large variety of gaming devices have been developed. In general gaming devices allow users or players to play a game. In many casino-type gaming devices, the outcome of the game depends, at least, in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,843,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

Gaming devices in casinos are more successful when they are able to captivate and hold a game player's interest for a long period of time. When a game player plays a gaming device for a longer period of time, more revenue is generated for the casino. A game player may lose interest with a game that has a static display that changes very little over time or that the player deems to be unattractive.

One way gaming device manufacturers have added additional enjoyment and excitement to gaming devices is through the advent of progressive gaming. Progressive games have become very popular in casinos. Progressive slot machines contain jackpots that increase every time a player places a wager in a primary game of the slot machine. Progressive jackpots involve one or more gaming machines. For example, an individual progressive slot machine has a self-contained jackpot, wherein the jackpot grows with every play of that machine. A linked progressive includes two or more slot machines at the same or different locations connected to a common jackpot, each of which individually contribute to the jackpot. The gaming machines usually take a percentage of the player's wager, such as 2%, and add it to the progressive jackpot. This allows the progressive jackpot to grow over time. The progressive jackpots can reach sizeable amounts, such as multi-million dollar jackpots, before a player “hits” or wins the progressive jackpot.

Large progressive jackpots can be very attractive to casino game players. Furthermore, as the progressive jackpot grows, so does the game's payout percentage because the game pays out more while the likelihood of receiving the progressive award or jackpot remains constant. Players looking to inject skill or strategy into a gaming event therefore look to find progressive games having relatively high progressive jackpots, i.e., games that have not recently paid out. In an effort to further increase the excitement and enjoyment of progressive games and gaming devices in general, it is therefore desirable to inject player interaction, skill, strategy or risk into a progressive gaming device.

Progressive jackpots pay awards very infrequently. The long periods of time between progressive awards causes progressive gaming displays to appear to be very static or slowly changing. Gaming machine players may eventually lose interest in the game and stop playing. This is especially true in casino locations where a large number of linked progressives are located. It can appear to a game player in these locations that there are no winning game players and that the progressive prize will almost never be awarded. A progressive gaming device that has a display that changes parameters and funding of the progressive jackpot game more frequently can increase and prolong player interest.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide longer play times and a greater payout possibility for a player;

provide greater revenues for gaming operators;

provide a gaming device that can fond a progressive jackpot from a bonus award;

provide a gaming device that utilizes a visually appealing and highly visible display;

provide a gaming device that can add a portion of a bonus prize to a progressive jackpot;

provide a gaming device that can increase a progressive jackpot at the same time a bonus prize is awarded; and

provide a gaming device that can add all of a bonus prize to a progressive jackpot.

These and other advantages may be realised by reference to the remaining portions of the specification, claims, and abstract.

### Brief Description of One Embodiment of the Present Invention

In certain embodiments, the present invention relates to a gaming apparatus that includes a primary gaming device that is adapted to accept a wager and allow a player to play a game. A bonus gaming device is mounted in association with the primary gaming device. The bonus gaming device can award a bonus prize. A controller is in communication with the primary gaming device and the bonus gaming device. The controller is adapted to determine the bonus prize and to provide a progressive jackpot. When a bonus prize is awarded, the progressive jackpot is funded.

In other embodiments, the present invention relates to a gaming method. According to the method, a player is allowed to place a wager and play a first game and it is determined if a bonus qualifying event has occurred. If the bonus qualifying event has occurred, a player is allowed to play a second game. A second game outcome is determined. The second game outcome comprises awarding at least one prize. If the second game outcome is awarding the prize, an amount is added to a progressive jackpot.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not he regarded as limiting.

### BRIEF DESCRIPTION OF THE DRAWINGS

FIG. 1 is substantially a front view of a gaming apparatus of the present invention.

FIG. 2 is substantially a schematic diagram of a portion of the gaming apparatus of FIG. 1.

FIG. 3 is substantially a schematic diagram of several of the gaming apparatuses of FIG. 1 connected in a network.

FIG. 4 is substantially a front view of FIG. 1 showing one possible game display.

FIG. 5 is substantially a flowchart of a gaming method of the present invention.

FIG. 6 is substantially a front view of FIG. 1 showing another possible game display.

FIG. 7 is substantially a front view of FIG. 1 showing an additional possible game display.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Game Apparatus

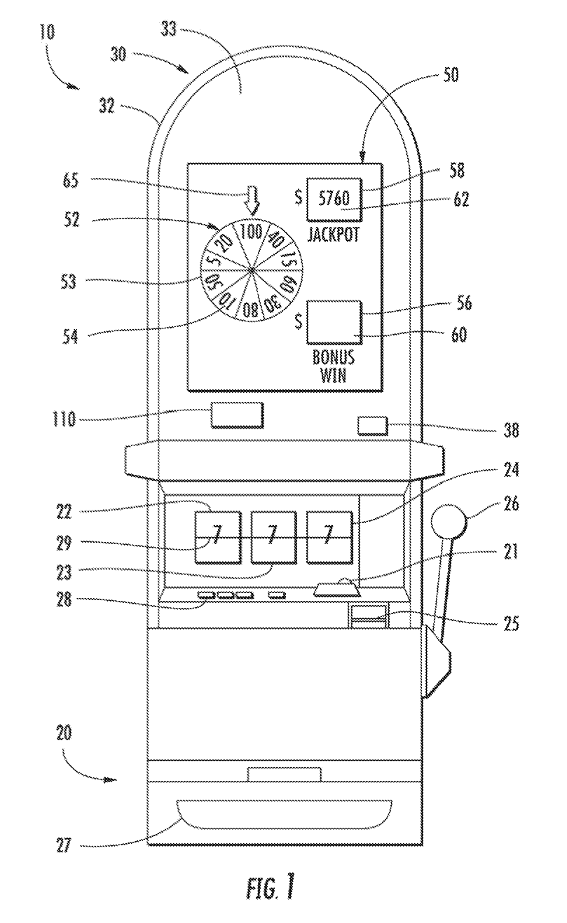

Referring to FIG. 1, one embodiment disclosed herein comprises a gaming apparatus or device, generally indicated by reference number 10. Gaming apparatus 10 comprises a base or primary gaming device 20 and a bonus gaming device 30. Bonus gaming device 30 may comprise a display or a display device 50 and a progressive jackpot 58. Primary gaming device 20 may be any of a large number of devices that are adapted to allow players to play a base or primary game. For example, gaming device 20 may utilize reel displays, such as spinning reels 22-24 and a payline 29 or a video display (not shown), to display outcomes of the game. Means may also be provided for accepting wagers, such as a coin slot 21 or card reader 25, and for awarding prizes, such as a coin dispenser 27. A handle 26 and button 28 are provided for activating gaming device 20 to begin a game. In at least one embodiment, gaming device 20 may be an S Plus model gaming device manufactured by International Game Technology in Reno, Nev.

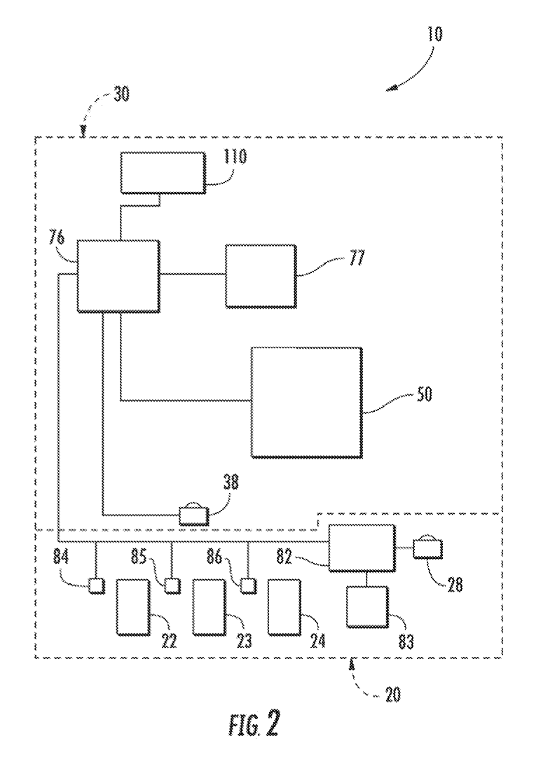

Referring to FIG. 2, primary gaming device 20 may be controlled by an electronic controller 82 that utilizes a random number generator 83. The random number generator 83 produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 of the video display to show the outcome of the game that corresponds to the outcome of the random number generator 83. It is recognized that gaming device 20 may operate in many other ways and still achieve the objects of the present invention.

Gaming device 20 may also be capable of producing a bonus qualifying or awarding event. This event may be many different types of events. For example, a bonus qualifying or awarding event may comprise displaying a particular symbol, such as a “bonus” symbol, or combination of symbols, such as three “7” symbols, on reels 22-24 as shown in FIG. 1. If the game being played is poker based, the bonus qualifying event may be occurrence of a certain hand, such as a royal flush. Furthermore, a bonus qualifying event may occur when a player accumulates a number of symbols or game outcomes over a number of separate game plays. For example, a bonus qualifying event may occur when the player receives three “bonus” symbols during a period of time. The bonus awarding event may be based on an external event.

Bonus Gaming Device

Referring to FIGS. 1 and 2, a bonus game apparatus, bonus display device or bonus gaming device 30 may have a housing 32 with a front panel 33. Housing 32 can be made from many different materials such as metal or plastic and can include decorative coverings or attachments and lights. A player input device 38 can be mounted in housing 32. Player input device 38 can be buttons or handles or rotary knobs. Player input device 38 can allow a game player to provide input to bonus gaming device 30. A display 110 such as a credit meter can be used to display prizes won on bonus gaming device 30 or primary gaming device 20.

A display 50 such as a video display can be mounted in front panel 33. Display 50 can be any suitable display including video displays, plasma displays, LCD displays, LED meters and the like. Display 50 may be a single display or can be more than one display.

As seen in FIG. 1, display 50 is shown displaying a video presentation of a prize disc or rotating prize wheel 52. Wheel 52 can be divided into several pie shaped sections or segments 53. Each of the segments displays at least one prize indicia 54. An indicator 65 such as an arrow can indicate one or more of prize indicia 54 as a prize or game outcome.

In an embodiment, wheel 52 may rotate and stop such that one of segments 53 is aligned with indicator 65 and the indicia 54 contained by the aligned segment can be a game outcome. Rotating wheel 52 may start to rotate and then stop. Rotating wheel 52 may rotate clock-wise or counter-clockwise.

Display 50 also has a bonus meter 56. Bonus meter 56 can display the award value 60 of any bonus prizes that are to be awarded.

The combination of one of indicia 54 and indicator 65 can indicate a game outcome. For example as shown in FIG. 1, a game outcome of 100 credits is indicated. Indicia 54 can be monetary amounts or may be a multiplier of a base game payout or may be physical prizes such as tickets to a show or restaurant passes. After rotating wheel 52 has stopped and indicated a game outcome, the credits won may be added to bonus meter 56.

In another embodiment, video prize wheel 52 may be replaced by a physical mechanical wheel (not shown) that is rotated and stopped by a rotary actuator (not shown) in order to rotate the mechanical wheel. Prize indicia can be displayed on the rotating mechanical wheel.

Bonus gaming device 30 may be activated upon the occurrence of a bonus qualifying or awarding event in primary gaming device 20. For example, a bonus qualifying event may comprise displaying a particular symbol, such as a “bonus” symbol, or combination of symbols, such as three “7” symbols, on reels 22-24 as shown in FIG. 1. Activation of bonus gaming device 30 may include activation of lights and sounds and activation of player input device 38. Player input device 38 may have to be depressed by a player in order to start rotation of wheel 52.

Progressive jackpot 58 is shown in a separate area of display 50. Alternatively, progressive jackpot 58 could be shown on a separate LED meter. Progressive jackpot 58 has an associated indicia or progressive jackpot award value 62 that can be awarded to a player as a prize. Progressive jackpot award value 62 can be a wide variety of awards, such as trips, vouchers, gaming credits, comps for meals or hotels or monetary awards. A game player playing gaming apparatus 10 may be awarded progressive jackpot 58.

Progressive jackpot 58 can be funded in a conventional manner wherein a percentage or portion of the wagers placed on several linked gaming devices 10 are reserved to increase the amount of the progressive jackpot. A portion of each wager is deducted from the wager and added to the progressive jackpot thereby increasing the amount of the progressive jackpot over time until the progressive jackpot is awarded.

Progressive jackpot 58 can also be funded when a bonus prize is awarded. A portion of the bonus prize award can be deducted and added to increase the amount of the progressive jackpot. Alternatively, when a bonus prize is awarded, an amount can be added to progressive jackpot without reducing the bonus prize. In another embodiment, all of the bonus prize may be contributed to increase the progressive jackpot.

Group of Gaming Apparatuses

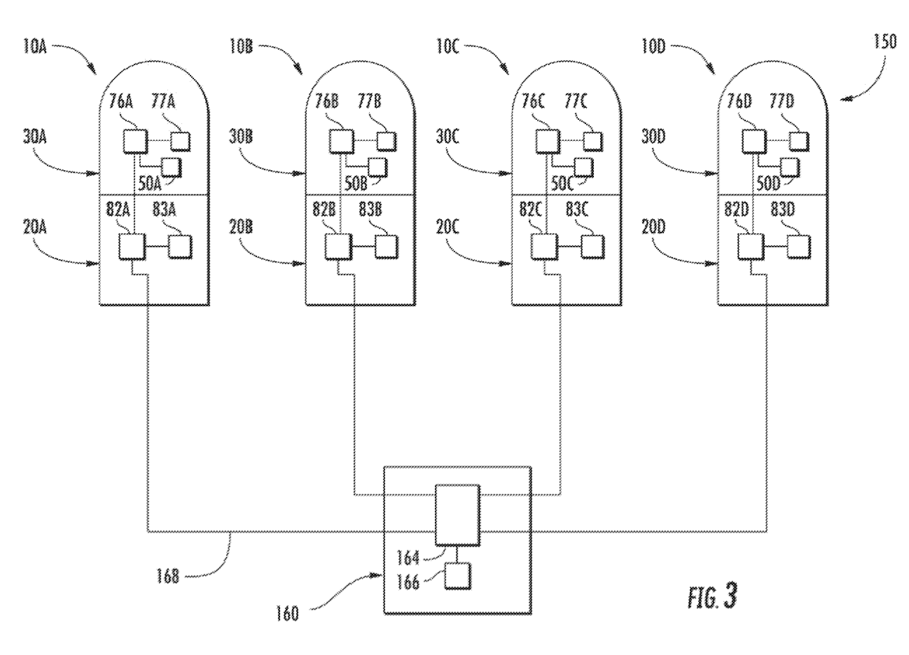

With reference to FIG. 3, a network 150 of gaming apparatuses 10A-D is shown. Network 150 can include several interconnected gaming apparatuses 10A, 10B, 10C and 10D. While four gaming apparatuses are shown, more or less can be used. Gaming apparatuses 10A-D can each have a primary gaming device 20A-D and a bonus gaming device 30A-D, respectively. Each of primary gaming devices 20A-D can have a controller 82A-D and random number generator 83A-D, respectively.

Gaming apparatuses 10A-D may he positioned in a side by side manner in a casino. Gaming apparatuses 10A-D may also be positioned in a back to back manner in a casino. Gaming apparatuses 10A-D may be designed with highly attractive displays and be visible to a large number of casino patrons.

Gaming apparatuses 10A-D may be in communication with a computer network server 160 through cables 168 such as an Ethernet cable or through a wireless connection. Server 160 can be a conventional network server that contains a memory 166, a controller or processor 164 and software that can operate on the processor. Processor 164 may also contain an internal random number generator.

Server 160 can collect and transmit game information and instructions between server 160 and gaming apparatuses 10A-D. For example, server 160 can determine which bonus gaming devices award bonus prizes or a progressive jackpot. Server 160 can also deduct or apportion a percentage of each wager placed on gaming apparatuses 10A-D to fund progressive jackpot 58. In an embodiment, 1% percent of any wagers placed on gaming apparatuses 10A-D may be deducted from the wager and contributed or added to fund progressive jackpot 58.

When a large number of gaming apparatuses are linked together, very large progressive jackpots may result.

Turning now to FIGS. 1, 2 and 3, bonus gaming device 30 comprises a controller 76 that is adapted to control the operation of the bonus gaming device. Controller 76 may be one or more micro-computers or processor boards. Random number generator 77 may be in communication with controller 76. Random number generator 77 is capable of randomly generating a random number and providing the random number to controller 76. As shown in FIG. 3, each of bonus gaming devices 30A-D contains controllers 76A-D and random number generators 77A-D, respectively. Controllers 76A-D are further in communication with and can control displays 50A-D.

It is recognized that controller 76 and random number generator 77 may be a single processor or processor board. Furthermore, it is also recognized that controllers 76 and 82, and random number generators 77 and 83 may be combined in a single processor or processor board. Each of controllers 76A-D may be in communication with server 160 (FIG. 3) either directly or indirectly through controllers 82A-D.

Server 160 and controllers 76A-D can determine the amount of any bonus prizes indicated and awarded on wheel 50 and can maintain and determine the size of progressive jackpot 58 (FIG. 1). Server 160 and controllers 76A-D can also maintain and determine the amount and method of funding of progressive jackpot 58. Server 160 and controllers 76A-D can further cause each of displays 50A-D in gaming devices 10A-D to display a video presentation of prize wheel 52, bonus display 56 and progressive jackpot 58.

In an alternative embodiment, server 160 can control the entire operation of progressive gaming devices 30A-D and controllers 76A-D can be omitted.

Controller 76 is adapted to detect when a bonus qualifying or awarding event occurs in gaming device 20. This may be accomplished by gaming device controller 82 transmitting a signal to controller 76 that a bonus qualifying event has occurred. For example, controller 82 may determine the outcome of each game and when a bonus qualifying event outcome occurs, it transmits a signal to controller 76. Alternatively, controller 76 may periodically interrogate controller 82. In another embodiment, one or more sensors may be provided for determining if a bonus qualifying event has occurred. For example, sensors 84-86 may sense the positions of reels 22-24. When reels 22-24 are in a bonus qualifying event activating position, controller 76 would sense this position and begin a bonus game sequence (described below).

Controllers 76A-D or 82A-D can each inform server 160 that a bonus qualifying event has occurred in gaming apparatuses 10A-D.

When controller 76 detects a bonus qualifying event, it may begin a bonus game sequence by activating display 110. Display 110 may comprise many different kinds of display devices, such as video screens, lights, light emitting diodes, etc. Display 110 may comprise its own controller that is adapted to generate a variety of displays.

Display 110 may indicate that a player has qualified for a bonus game and prompt the player to perform an action. In an embodiment, the player is prompted to start the bonus game by pressing input device 38. Input device 38 may be a simple button, a keyboard, or a touch screen display.

When controller 76 detects input device 38 being activated, controller 76 performs a routine to determine which bonus prize will be awarded. In an embodiment, the bonus prize to be awarded is randomly selected. Random number generator 77 generates a random number and supplies the random number to controller 76. Controller 76 compares the random number to a pay table similar to that described for game device 20 or as described in U.S. Pat. No. 5,823,874, issued to Adams. A simple pay table may appear as follows:

TABLE 1

| Random Number | Bonus Prize |
|---|---|
| 0.00 to 0.42 | 5 |
| 0.43 to 0.63 | 10 |
| 0.64 to 0.74 | 15 |
| 0.75 to 0.80 | 20 |
| 0.81 to 0.85 | 30 |
| 0.86 to 0.89 | 40 |
| 0.90 to 0.93 | 50 |
| 0.94 to 0.96 | 60 |
| 0.97 to 0.98 | 80 |
| 0.99 to 1.0 | 100 |

For example, if the random number generator produced 0.66, a bonus prize of 15 credits would be indicated as being won and awarded to the player. If the random number generator produced 0.95, 60 credits would be indicated as being won and would be awarded to the player. This embodiment is not necessarily limited to the example pay table shown. A larger or fewer number of bonus prizes may be used. Furthermore, different kinds of bonus prizes may be awarded. For example, a bonus prize and a vacation could be awarded or a bonus prize and an award to play additional games could be awarded.

Once controller 76 randomly determines which bonus prize is to be awarded, controller 76 may cause video display 50 to rotate wheel 52 to indicate the bonus prize that has been won. Controller 76 directs video display 50 to rotate and stop wheel 52 such that the desired game outcome indicia 54 is aligned with indicator 65.

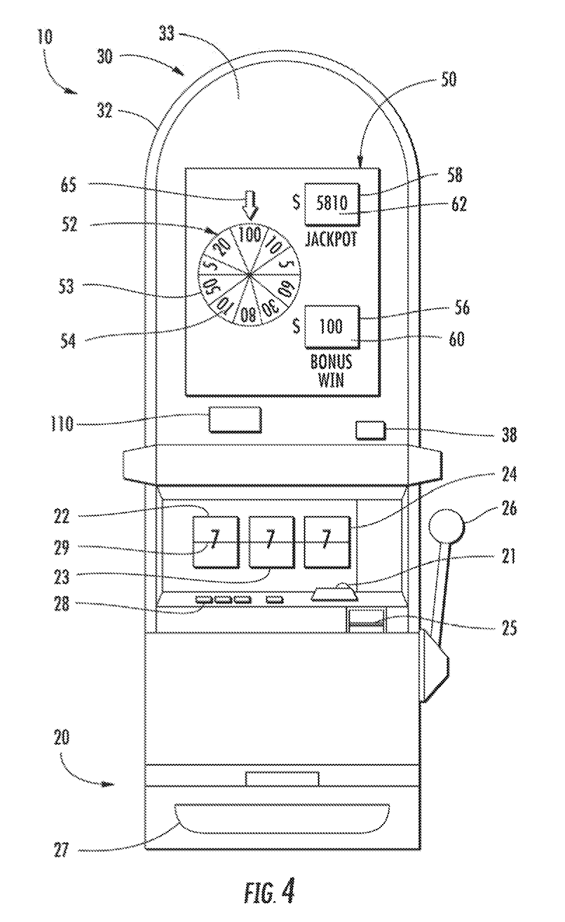

With reference now to FIG. 4, prize wheel 52 is shown indicating that the game player has won a bonus prize of 100 credits or dollars. Indicator 65, such as an arrow, may be illuminated or flashed above the selected prize indicia 54 in order for a game player to clearly see what prize they have won.

Controller 76 may then cause bonus display 56 to display the bonus prize, if any, that the player has won. In FIG. 4, bonus display 56 is showing a bonus award value of “100”. Other effects may also be presented, such as pre-recorded sound from speakers. If the actual prize is money, the amount of the prize may be added to the player's credit meter or dispensed.

At the same time or shortly after a bonus prize has been awarded, controller 76 may cause a progressive jackpot funding event to occur. In other words, the occurrence of a bonus prize may trigger or start a jackpot funding event or sequence.

In one embodiment, an additional amount is added to the progressive jackpot upon the occurrence of a bonus award or prize. The awarding of a bonus prize triggers an increase to the progressive jackpot.

As seen in FIG. 1, progressive jackpot 58 has an award value 62 of “$5760”. After a bonus prize has been awarded, controller 76 adds or contributes an amount equal to 50 percent of the bonus award to increase progressive jackpot 58. Turning now to FIG. 4, controller 76 has added “$50” to award value 62 of progressive jackpot 58 in response to the bonus award of “$100”. Progressive jackpot 58 now has a new award value 62 of “$5810”. Controller 76 can add a portion of the bonus prize amount or can add an amount to the progressive jackpot. A game player playing gaming apparatuses 10A-D (FIG. 3) is now playing for a larger progressive jackpot.

In one embodiment, the percentage or portion of the amount of the bonus award to be added to the progressive jackpot may be randomly determined by the controller or the server.

Players playing gaming apparatus 10A-D will feel a sense of excitement and anticipation when they see adjacent or adjoining players qualifying for bonus games knowing that soon they will be playing for a larger progressive jackpot.

Controller 76 is also adapted to detect when a progressive jackpot awarding or qualifying event occurs in gaming device 20. This may be accomplished by controller 82 transmitting a signal to controller 76 that a progressive jackpot qualifying event has occurred. For example, controller 82 may determine the outcome of each game and when a progressive jackpot qualifying event outcome occurs, it transmits a signal to controller 76. Alternatively, controller 76 may periodically interrogate controller 82. In another embodiment, one or more sensors may be provided for determining if a progressive jackpot qualifying event has occurred. For example, sensors 84-86 may sense the positions of reels 22-24. When reels 22-24 are in a progressive jackpot qualifying event activating position, controller 76 would sense this position and begin a progressive game sequence (described below).

Controllers 76A-D or 82A-D can each inform server 160 that a progressive jackpot qualifying event has occurred in gaming apparatuses 10A-D. Alternatively, server 160 may determine when a jackpot qualifying or awarding event occurs and transmit a signal to one of controllers 76A-D.

When controller 76 detects a progressive jackpot qualifying or awarding event or is informed of a progressive jackpot qualifying event, it may begin a progressive jackpot sequence. Controller 76 causes video display 50 to display a video presentation that indicates that progressive jackpot 58 has been won. An indicator such as an arrow (not shown) may be illuminated or flashed above the progressive jackpot in order for a game player to clearly see what they have won.

Controller 76 may then cause display 110 to display the total prize, if any, that the player has won. Other effects may also be presented, such as pre-recorded sound from speakers. After progressive jackpot 58 has been awarded, server 160 (FIG. 3) then updates displays 50A-D on each of gaming apparatuses 10A-D with at least one new progressive award value. For example, progressive jackpot 58 maybe set to zero and would then start accumulating value when a bonus prize awarding event occurs.

It is also possible to replace the primary display of a gaming device with bonus gaming device 30. In other words bonus gaming device 30 can also be used as a primary or base game apparatus.

Gaming apparatus 10 may also be used with multi-level progressive jackpots. In a multi-level progressive jackpot game, several progressive jackpots are provided that are in a particular order and game players must win each jackpot in sequence before they are eligible to win the next progressive jackpot.

In an embodiment, progressive jackpot 58 may be a hidden or mystery jackpot with a hidden or mystery award value. The award value is not revealed to a game player until after the progressive jackpot has been won.

Game Method

Referring now to FIGS. 1, 2 and 5, a flowchart of a method of game play 200 using gaming apparatuses 10A-D and network 150 (FIG. 3) is shown. At step 202, a player may initiate game play method 200 by placing a wager on one of gaming apparatuses 10. The wager may be in form of cash or credit from actual domestic or foreign currency, vouchers, coupons, tickets, electronic cards, and other sources or forms of wagers known in the art. Once the player initiates game play, the primary game random number generator generates a first random number and randomly determines the base game outcome at step 203. Next, the player may play a base or primary gaming device 20 at step 204.

At decision step 210, the controller checks for or detects the occurrence of a bonus awarding or qualifying event. If the controller does not detect a bonus qualifying event, method 200 proceeds to decision 216.

If the controller detects that a bonus qualifying event has occurred at decision step 210, method 200 proceeds to step 212 where the bonus prize and amount to fund, contribute or add to the progressive jackpot 58 is determined. At step 213, the funding or contribution amount is added to progressive jackpot 58. The bonus prize is shown on bonus meter 56 and the new value of progressive jackpot 58 is displayed in step 214. At step 215, the bonus prize is awarded to the player. From step 215, method 200 continues to decision 216.

At decision 216, the controller checks for the occurrence of a jackpot qualifying or awarding event. If the controller does not detect a jackpot awarding event, method 200 proceeds to step 220 where any additional progressive jackpot funding from wagers placed on primary gaming device 10 is determined.

If the controller detects a jackpot awarding event at decision step 216, controller 76 awards progressive jackpot 58 to the player at step 218. Next method 200 proceeds to step 220 where any additional progressive jackpot fending from wagers placed on primary gaming device 10 is determined. Step 220 may include apportioning a percentage of the wagers on primary gaming devices 20A-D and determining the percentage to apportion. Progressive jackpot 58 is incremented in step 222.

Next, the controller notifies the player of the game outcome from the base game at step 208. Method 200 then returns to step 202 where the player may place another wager and play one of gaming apparatuses 10 again.

The steps shown in the flowchart do not necessarily imply that the steps have to take place in a particular order. The order of steps may he varied; some steps may he eliminated; and, some steps may be replaced with other steps. Such variations still fall within the scope of the invention.

### First Alternative Embodiment

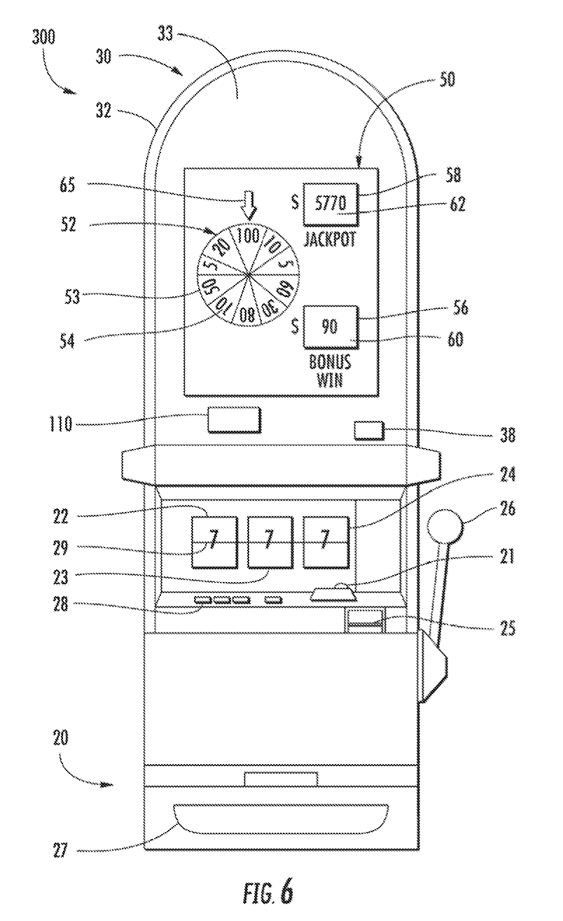

With reference now to FIG. 6, another embodiment of a gaming apparatus 300 in accordance with the present invention is shown. Gaming apparatus 300 is similar to gaming apparatuses 10 except that when a bonus prize is won, a fixed amount or portion of the bonus prize is deducted from the bonus prize and is added to the progressive jackpot rather than being awarded to the player. A plurality of gaming apparatuses 300 can be connected in a network 150 as was described for gaming apparatuses 10.

Prize wheel 52 is shown indicating that the game player has won a bonus prize of “$100”. Indicator 65, such as an arrow, may be illuminated or flashed above the selected prize indicia 54 in order for a game player to clearly see what prize they have won.

Controller 76 may then cause bonus display 56 to display the bonus prize that the player has won. Bonus display 56 is showing a bonus award value 60 of “$90”.

At the same time or shortly after a bonus prize has been awarded, controller 76 may cause a progressive jackpot funding event to occur. In other words, the awarding of a bonus prize may trigger or start a jackpot funding event or sequence.

In one embodiment, the bonus prize is reduced or deducted by a portion or fixed amount to be added to the progressive jackpot. In FIG. 6, the fixed amount is “$10”. Ten dollars has been deducted from the bonus prize shown on wheel 52 and “$10” has been added to progressive jackpot 58 in FIG. 6 as compared to FIG. 1. Progressive jackpot 58 now has a new award value 62 of “$5770” as shown in FIG. 6. In one embodiment, the fixed amount or portion deducted from the bonus prize and added to the progressive jackpot may be randomly determined by the controller or the server.

Gaming apparatus 300 therefore can deduct a portion of the bonus prize and add the deducted portion to fend or contribute to a progressive jackpot. Gaming apparatus 300 can cause the progressive jackpot to increase and be funded more frequently.

In one embodiment, a portion of the bonus prize may only be deducted and added to the progressive jackpot if the bonus prize has a value that is larger than a predetermined value. For example, a portion of the bonus prize may be deducted to contribute to or increase the progressive jackpot only when the bonus prize that is awarded is greater than $50.

Players playing gaming apparatus 300 will feel a sense of excitement and anticipation when they see adjacent or adjoining players qualifying for bonus games knowing that soon they will be playing for a larger progressive jackpot.

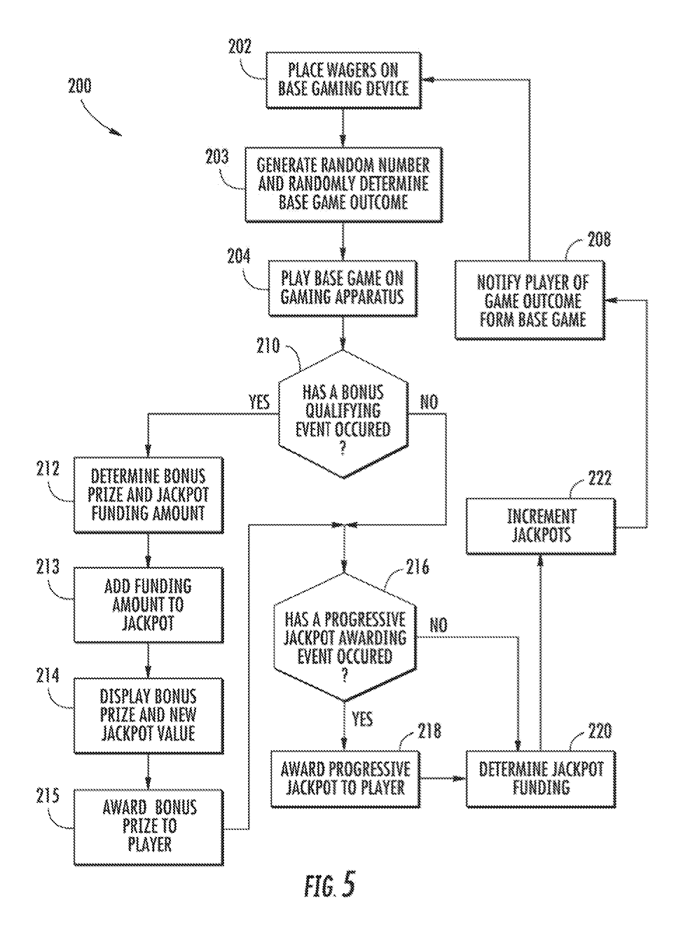

Gaming apparatus 300 can award progressive jackpot 58 in the same manner previously described for gaming apparatus 10. Gaming apparatus 300 can be played using the same method previously described for gaming apparatus 10 in FIG. 5.

### Second Alternative Embodiment

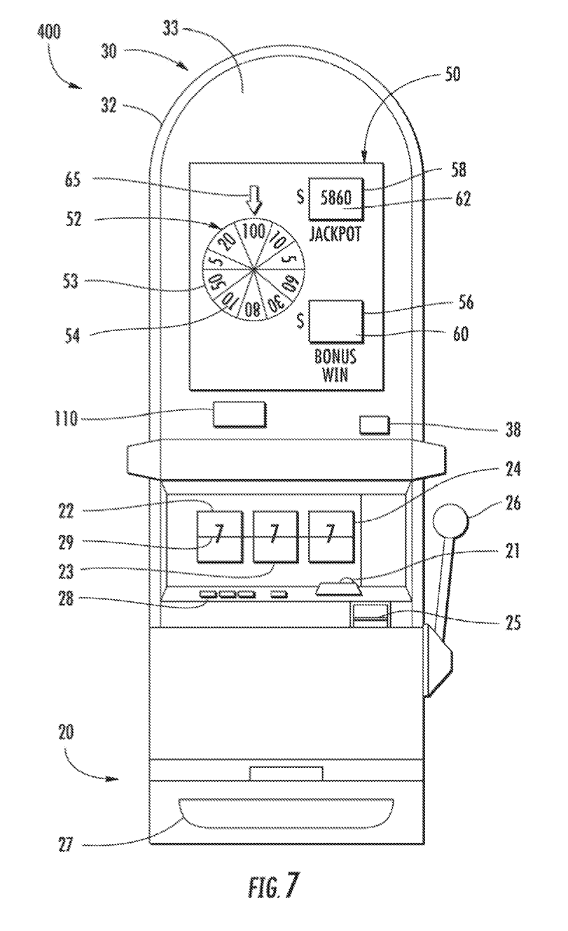

With reference now to FIG. 7, another embodiment of a gaming apparatus 400 in accordance with the present invention is shown. Gaming apparatus 400 is similar to gaming apparatus 10 except that when a bonus prize is won, all or the entire amount of the bonus prize is added to the progressive jackpot rather that) being awarded to the player. A plurality of gaming apparatuses 400 can be connected in a network 150 as was described for gaming apparatuses 10.

Prize wheel 52 is shown indicating that the game player has won a bonus prize of “$100”. Indicator 65, such as an arrow, may be illuminated or flashed above the selected prize indicia 54 in order for a game player to clearly see what prize they have won.

Controller 76 may then cause bonus display 56 to display the bonus prize that the player has won. Bonus display 56 is showing a bonus award value 60 of none.

At the same time or shortly after a bonus prize has been awarded, controller 76 may cause a progressive jackpot funding event to occur. In other words, the awarding of a bonus prize may trigger or start a jackpot funding event or sequence.

In one embodiment, the entire bonus prize is added to the progressive jackpot. In FIG. 7, the entire bonus prize shown on wheel 52 of “100” has been added to progressive jackpot 58 in FIG. 7 as compared to FIG. 1. Progressive jackpot 58 now has a new award value 62 of “$5860” as shown in FIG. 7.

Gaming apparatus 400 therefore can use all of the bonus award or prize to fund or contribute to a progressive jackpot. Gaming apparatus 400 can cause the progressive jackpot to increase and be funded more frequently.

Players playing gaming apparatus 400 will feel a sense of excitement and anticipation when they see adjacent or adjoining players qualifying for bonus games knowing that soon they will be playing for a larger progressive jackpot.

Gaming apparatus 400 can award progressive jackpot 58 in the same manner previously described for gaming apparatus 10. Gaming apparatus 400 can be played using the same method previously described for gaming apparatus 10 in FIG. 5.

Conclusion

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming apparatus comprising:
(A) at least one primary gaming device that is adapted to accept a wager and allow a player to play a game;
(B) at least one bonus gaming device mounted in association with the primary gaming device, the bonus gaming device being adapted to award at least one bonus prize; and
(C) a controller in communication with the primary gaming device and the bonus gaming device, the controller being adapted to determine the bonus prize and to provide a progressive jackpot, wherein when a bonus prize is awarded, the progressive jackpot is funded.

2. The gaming apparatus of claim 1, wherein a portion of the bonus prize is deducted from the bonus prize and added to the progressive jackpot.

3. The gaming apparatus of claim 1, wherein all of the bonus prize is added to the progressive jackpot.

4. The gaming apparatus of claim 2, wherein the portion of the bonus prize is randomly determined.

5. The gaming apparatus of claim 1, wherein a portion of the bonus prize is added to the progressive jackpot.

6. A method of gaming, comprising, not all necessarily in the order shown:
(A) allowing a player to place a wager and play a first game;
(B) determining if a bonus qualifying event has occurred;
(C) if the bonus qualifying event has occurred, allowing a player to play a second game;
(D) determining a second same outcome, the second game outcome comprising awarding at least one prize; and
(E) if the second game outcome is awarding the prize, adding an amount to a progressive jackpot.

7. The method of claim 6, wherein at least a portion of the amount is deducted from the prize.

8. The method of claim 7, wherein the portion of the amount is deducted from the prize only if the prize is larger than a pre-determined value.

9. The method of claim 6, wherein none of the amount is deducted from the prize.

10. The method of claim 6, wherein all of the amount is deducted from the prize.

11. A gaming apparatus comprising:
(A) gaming means for allowing a player to play a first game and a second game;
(B) display means for displaying a bonus prize and a progressive jackpot; and
(C) server means for determining a bonus awarding event, the server means in communication with the gaming means and the display means, the server means being adapted to determine a bonus awarding event and if the bonus awarding event occurs, to increase the progressive jackpot.

12. The gaming apparatus of claim 11, wherein the progressive jackpot is increased by at least a portion of the bonus prize.

13. The gaming apparatus of claim 12, wherein the portion is deducted from the bonus prize.

14. The gaming apparatus of claim 11, wherein all of the bonus prize is added to the progressive jackpot.

15. The gaming apparatus of claim 12, wherein the portion is randomly determined.

16. A gaming apparatus comprising:
(A) at least one primary gaming device that is adapted to accept a wager and allow a player to play a primary game;
(B) at least one bonus gaming device mounted in association with the primary gaming device, the bonus gaming device being adapted to award a bonus prize; and
(C) a controller in communication with the primary gaming device and the bonus gaming device, the controller being adapted to:
(a) determine a bonus game outcome;
(b) maintain a progressive jackpot; and
(c) if the bonus game outcome is a bonus prize awarding event, increase the progressive jackpot.

17. The gaming apparatus of claim 16 wherein a portion of the bonus prize is deducted from the bonus prize and added to the progressive jackpot.

18. The gaming apparatus of claim 16, wherein all of the bonus prize is added to the progressive jackpot.

19. The gaming apparatus of claim 1, wherein when the progressive jackpot is increased, the bonus prize is not reduced.
